(19) United States
(12) Patent Application Publication
(10) Pub. No.: US 2024/0396649 A1
(43) Pub. Date: Nov. 28, 2024

(54) METHOD AND COMMUNICATION DEVICE FOR ADAPTING WIRELESS PARAMETERS

(71) Applicant: Diehl Metering Systems GmbH, Nürnberg (DE)

(72) Inventors: Hristo Petkov, Nürnberg (DE); Aditya Singh, Erlangen (DE); Thomas Kauppert, Nürnberg (DE)

(21) Appl. No.: 18/672,399

(22) Filed: May 23, 2024

(30) Foreign Application Priority Data
May 23, 2023 (DE) 10 2023 113 502.3

(51) Int. Cl. H04B 17/318; H04B 17/391

(52) U.S. Cl. CPC H04B 17/318; H04B 17/3913

(57) ABSTRACT

A method adjusts wireless parameters within a bidirectional wireless network having a multiplicity of wireless nodes and a gateway. Wireless connections are provided between the gateway and the wireless nodes. The wireless network is provided as a first digital twin in the wireless node or the gateway or in a wireless-network external head-end. The received signal strength indicator (RSSI) of each of the wireless connections is determined or estimated, and the path loss of the respective wireless connections is determined or estimated from the associated RSSI. The path loss of each of the wireless connections is assigned to the respective wireless connections of the first digital twin, and wherein, on the basis of the path loss of each of the wireless connections of the first digital twin, at least one wireless parameter is adjusted for a future data transmission for at least one wireless connection of the wireless network.

### CROSS-REFERENCE TO RELATED APPLICATION

This application claims the priority, under 35 U.S.C. § 119, of German Patent Application DE 10 2023 113 502.3, filed May 23, 2023; the prior application is herewith incorporated by reference in its entirety.

### FIELD AND BACKGROUND OF THE INVENTION

The present invention relates to a method for adapting wireless parameters according to the independent method claim, and to a communication device according to the independent communication device claim.

The present invention relates to a method for adapting wireless parameters in a bidirectional wireless network. A wireless network of this type contains a multiplicity of wireless nodes and at least one gateway. In addition, a wireless-network external head-end is provided, which communicates with the gateway. The wireless nodes can communicate with the gateway and/or the head-end, exchanging data in the process. In an uplink transmission, a wireless node transfers data to the gateway, which can forward this data to the head-end. In a downlink transmission, on the other hand, data is sent from the gateway to the wireless node. In this case, the gateway can receive the downlink transmission from the head-end.

A wireless node can be a sensor device for capturing data of any type, an actuator device for performing certain actions or measures, or a combination of a sensor device and an actuator device. Such wireless nodes are powered by their own, i.e. self-sufficient, energy supply in the form of a battery, preferably a long-life battery, which has a limited operating life depending on the specific energy consumption of the wireless node and is not rechargeable. The batteries cover the entire operating life of the meter, which typically lies in the range of 10 to 16 years.

The data transmission in such a network usually takes place in an unsynchronized manner. This can result in mutual interference between the radio signals of the uplink transmissions from the individual wireless nodes, reducing the reception quality or reception probability of the radio signals. This is the case in particular if a more powerful radio signal from a wireless node positioned close to the gateway interferes with the radio signal of a wireless node positioned away from the gateway. It is possible in this case that the gateway cannot receive the lower-power signal at all anymore. Interference or crosstalk can likewise occur during a downlink transmission for the same reasons.

Based on the prevailing conditions within the wireless network, a network management system can influence the wireless parameters of the wireless nodes or of the gateway such that the radio signals from the individual transmitters affect each other less strongly. This can increase the reception probability of radio signals regardless of the distance of the wireless nodes from the gateway.

European patent EP 3 133 825 B1, corresponding to U.S. Pat. No. 10,064,132, discloses a bidirectional wireless data-transmission method for unsynchronized transfer of measured-value datagrams from meters to a concentrator via an uplink wireless connection. In this method, at least one parameter of an uplink wireless connection is influenced on the basis of quality information of a received uplink wireless connection such that the quality of the uplink wireless connection falls, but the uplink wireless connection still works.

T. T. Nguyen, R. Caromi, K. Kallas and M. R. Souryal, “Deep Learning for Path Loss Prediction in the 3.5 GHZ CBRS Spectrum Band,” 2022 IEEE Wireless Communications and Networking Conference (WCNC), Austin, TX, USA, 2022, pp. 1665-1670, doi: 10.1109/WCNC51071.2022.9771737, describe a neural network for predicting path loss in a 3.5 GHz band.

### SUMMARY OF THE INVENTION

The object of the present invention is to provide a method that ensures improved adaptation of the wireless parameters in a wireless network.

The above object is achieved by a method having the features of the independent method claim and by a communication device having the features given in the independent communication device claim. The associated dependent claims claim expedient embodiments of the method according to the invention and of the communication device according to the invention.

According to the invention, a method for adapting wireless parameters of at least one wireless connection within a bidirectional wireless network is claimed, wherein the wireless network contains a multiplicity of wireless nodes and at least one gateway. The wireless connections are provided for data transmission between the gateway and the wireless nodes. The wireless network is provided or stored as a first digital twin in the wireless node or the gateway or in a wireless-network external head-end. The received signal strength indicator (RSSI) of each of the wireless connections between the gateway and the respective wireless nodes is determined or estimated, and the path loss, in particular the mean path loss, of the respective wireless connections is determined or estimated from the associated RSSI. The path loss of each of the wireless connections between the wireless nodes and the gateway is assigned to the respective wireless connections of the first digital twin, and wherein, on the basis of the path loss of each of the wireless connections of the first digital twin, at least one wireless parameter is adapted for a future, for instance the next, data transmission, in particular uplink transmission and/or downlink transmission, for at least one wireless connection between a gateway and a wireless node of the wireless network.

The first digital twin contains all the wireless nodes and all the gateways and the wireless connections of the wireless network. A wireless connection of the digital twin is assigned its associated path loss, which was ascertained for the associated wireless connection of the wireless network. The first digital twin thereby constitutes, for example, a digital representation or model of the wireless network. The first digital twin is located in a communication device, in particular in a control device of the communication device, which can adapt the wireless parameters of the wireless connections on the basis of the first digital twin. The communication device is a wireless node or the gateway or the head-end. For this purpose, the ascertained RSSI or the path loss is forwarded, for instance from the recipient of the data transmission concerned, i.e. of the uplink transmission and/or of the downlink transmission, to the communication device that comprises the first digital twin. Alternatively, the path loss or the RSSI is determined or estimated by the communication device containing the first digital twin. The downlink transmission is a data transmission from the gateway to a wireless node; the uplink transmission is a data transmission from the wireless node to the gateway.

By virtue of the first digital twin, the characteristics, for instance the RSSI and/or the attenuation and/or the quality and/or interferences sources, of the wireless connections are present as a bundle within the wireless network. On the basis of these characteristics, the at least one wireless parameter can now be adapted for a future data transmission for at least one wireless connection of the wireless network to the currently existing characteristics of the wireless connections, thereby increasing the reception probability for poorly receivable wireless nodes. For this purpose, the communication device on which the first digital twin is located informs the wireless node and the gateway of the associated wireless connection of those wireless parameters to be used for sending future data transmissions, for example an uplink transmission or a downlink transmission. The new wireless parameters are transmitted to the associated wireless node and/or the associated gateway in particular by means of preferably regular uplink transmissions and/or downlink transmissions. Hence the future data transmission can be performed using adapted wireless parameters, thereby influencing the reception probability and/or the quality of the radio signals. In particular, the transmit power of wireless nodes can be reduced by this means. As a result, the reception of previously poorly receivable wireless nodes positioned away from the gateway can now be improved, because their wireless connection is experiencing less interference from wireless nodes positioned close to the gateway. The at least one adaptable wireless parameter can be the transmit power and/or the length and/or the number of repetitions and/or transmit intervals and/or data rates and/or frequency channels and/or the time of transmission of an uplink transmission and/or of a downlink transmission.

The wireless network preferably additionally contains wireless connections between the wireless nodes themselves, wherein the RSSI of each of the wireless connections between the wireless nodes is determined or estimated, and wherein the path loss, in particular the mean path loss, of the associated wireless connection is determined or estimated from the associated RSSI. The path loss of each of the wireless connections between the wireless nodes is assigned to the respective wireless connections of the first digital twin, and wherein the path loss of each of the wireless connections of the first digital twin is additionally used to adapt the at least one wireless parameter for a future data transmission, in particular an uplink transmission and/or a downlink transmission, for at least one wireless connection of the wireless network. By determining the associated path loss between the wireless connections, it is possible to establish which wireless nodes are interfering with each other. The wireless parameters of the interfering wireless nodes can thus be adapted such that they do not interfere with one another for future data transmissions. For example, this can be achieved by switching off a wireless node temporarily or by changing the transmit intervals. Alternatively or additionally, individual wireless nodes, for instance, can be put into a sleep mode in which they do not send any data, so that they do not interfere with the adjacent wireless nodes.

Advantageously, the path loss is determined for all the wireless connections of the wireless network. Alternatively, the path loss can also be ascertained only for some of the wireless connections, for instance only for a certain portion of the wireless network.

As a result of determining or estimating, in particular from the path loss of the respective wireless connections, the path loss exponent of the individual wireless connections between the gateway and the wireless nodes and/or of the individual wireless connections between the wireless nodes themselves, a further parameter relating to the characteristics of the wireless connections of the wireless network is available that can likewise be assigned to the respective wireless connections of the digital twin. The path loss exponent in particular gives information about the location of the wireless node. A path loss exponent of 4 to 5 means that the wireless node is located in a city having numerous interference sources. In addition, a path loss exponent of about 3 means that the wireless node is in a small town or a rural area containing few interference sources. A path loss exponent of 2, however, means that there are no interference sources present.

Expediently, the at least one wireless parameter is adapted for a future data transmission for at least one wireless connection additionally according to the path loss exponent. By using two parameters, it is possible to achieve improved adaptation of the at least one wireless parameter to the actual characteristics of the wireless connections.

As a result of continually updating the path loss and/or the path loss exponent on the basis of the latest RSSI of the respective wireless connections, the path loss and the path loss exponent are adapted to the present characteristics of the wireless connections of the wireless network. The RSSI for a wireless connection is continuously ascertained in this process, and the path loss and/or the path loss exponent determined or estimated on the basis thereof.

For example, the path loss and/or the path loss exponent of each of the wireless connections between the gateway and the wireless nodes and/or of each of the wireless connections between the wireless nodes are continuously assigned to the respective wireless connections of the first digital twin. The first digital twin is thereby continuously adapted to the actual wireless network by the present path loss and/or the present path loss exponent. The first digital twin can thereby always constitute a digital copy of the actual wireless network. In particular, the first digital twin hence comprises not only the present path loss and/or the path loss exponent, but also the history of the associated path loss and/or of the associated path loss exponent for the respective wireless connections. Hence not only the present measured values but additionally also the historical measured values can be used in adapting the wireless parameters. For example, a moving average of the path loss or of the path loss exponent can be formed on the basis of the present measured values and the historical measured values. This can smooth out any measurement errors or outriders in the present characteristics of the wireless network.

In particular, further signal parameters of the individual wireless connections between the gateway and the wireless nodes and/or of the wireless connections between the wireless nodes are determined and used additionally by the digital twin to adapt the at least one wireless parameter for a future data transmission for at least one wireless connection of the wireless network. In particular, the signal parameters of the respective wireless connections of the wireless network are assigned to the respective wireless connections of the first digital twin. The first digital twin can thereby be adapted further to the relevant characteristics of the wireless network, thereby further improving the adaptation of the wireless parameters. Expediently, the wireless parameters are filtered and/or clustered before being supplied to the first digital twin. Expediently, the signal parameters are the received signal strength indicator (RSSI) and/or a signal-to-noise ratio (SNR) and/or a packet error rate (PER) and/or a bit error rate (BER).

Artificial intelligence is preferably provided for predicting or estimating a future path loss and/or a future path loss exponent and/or a future RSSI for the respective wireless connections between the gateway and the wireless nodes and/or between the wireless nodes. Expediently, the future path loss and/or the future path loss exponent and/or the future RSSI are predicted or estimated only for the next data transmission or for a next period of time, for instance for the next hour or the next minutes. The artificial intelligence can process the, in particular present and/or historical, path loss and/or the, in particular present and/or historical, path loss exponent and/or the, in particular present and/or historical, signal parameters of the respective wireless connections, for instance of the digital twin, and predict or estimate on the basis thereof the future path loss and/or the future path loss exponent for a wireless connection. On the basis of the future path loss and/or the future path loss exponent, the wireless parameters for a future, or the next, data transmission can be adapted particularly effectively to the expected or predicted characteristics of the wireless connection. The wireless parameters are hence adapted to the most likely characteristics of the wireless connection in the future. Expediently, the artificial intelligence is a machine learning program, i.e. artificial intelligence that supports machine learning. This allows the artificial intelligence, or the machine learning program, to be trained by the historical measured values of the path loss and/or of the path loss exponent and/or of the signal parameters. Expediently, the artificial intelligence is located in the control device of the wireless node or of the gateway or of the head-end, and is implemented in particular by a processor or chip.

By the artificial intelligence or the machine learning program additionally predicting or estimating the future signal power and/or the future reception probability, it is possible to make an even more accurate prediction of the future characteristics of the wireless connections of the wireless network, allowing a further improvement in the adaptation of the at least one wireless parameter.

As a result of using or employing the future path loss and/or the future path loss exponent and/or the future signal power and/or the future reception probability of the respective wireless connections to adapt the at least one wireless parameter for a future data transmission via a wireless connection of the wireless network, the at least one wireless parameter can be adapted particularly accurately to the predicted or expected characteristics of the wireless connections of the wireless network.

By using the, in particular historical, path loss and/or the, in particular historical, path loss exponent and/or the, in particular historical, signal parameters of the respective wireless connections to train the artificial intelligence or machine learning program, it is possible to recognize certain patterns and regularities in the characteristics of the wireless connections of the wireless network, thereby allowing a particularly precise prediction or estimate of the future characteristics of the wireless connections of the wireless network.

Expediently, the signal parameters are filtered and/or clustered or bundled before the training of the artificial intelligence or machine learning program. The filtering and the clustering can be performed by the artificial intelligence or machine learning program itself, or the filtering and clustering can be performed in advance, for instance by the control device.

The prediction or estimate by the artificial intelligence or machine learning program is preferably based on the method of maximum likelihood or the method of minimum mean square error.

By virtue of the artificial intelligence or machine learning program being able to establish a time at which a wireless node has the lowest path loss, it is possible to ascertain variations, in particular variations according to the time of day, in the characteristics of a wireless connection of the wireless network. It is possible here to adjust the wireless parameters of the wireless node such that it transmits only at the times of lowest path loss. This not only ensures that the data transmissions by the wireless node are received by a gateway, but also avoids unnecessary data transmissions, thereby allowing energy to be saved.

In particular, a second digital twin is provided in the wireless node or the gateway or the head-end, wherein the artificial intelligence comprises and uses the second digital twin, for instance to predict or estimate the future wireless characteristics of the wireless channels. The second digital twin contains all the wireless nodes and all the gateways and the wireless connections of the wireless network. In addition, in the same way as the first digital twin, it can comprise the characteristics of the wireless connections of the wireless network. As a result, the first digital twin reflects just the present characteristics of the wireless connections of the wireless network, and the second digital twin is used only for predicting or estimating the future wireless network. This creates redundancy.

The second digital twin preferably obtains information about the wireless network from the first digital twin. This information contains, for example, the structural design of the wireless network and/or the number of wireless nodes and/or the ID of the wireless nodes and/or the number of gateways and/or the identification numbers of the gateways and/or the characteristics of the individual wireless connections, in particular the RSSI and/or path loss and/or path loss exponent and/or signal parameters thereof.

The signal parameters are, for example:
a received signal strength indicator (RSSI); and/or
a signal-to-noise ratio (SNR); and/or
a packet error rate (PER); and/or
a bit error rate (BER).

The present characteristics of a wireless connection of the wireless network can be checked by the wireless node or the gateway sending a test data-packet before a data transmission. Test data-packets are short data packets that do not comprise payload data and therefore consume only a little energy for sending and/or receiving.

Preferably, a data exchange does not take place until the test data-packet is of sufficient quality. This can ensure that a data transmission takes place only when there is a certain probability that the data transmission will also be received. This achieves that no data transmissions are sent that have a low reception probability. In particular, the quality of the test data-packet is determined from the path loss and/or the path loss exponent and/or the aforementioned signal parameters.

In particular, the at least one wireless parameter is adapted for a future data transmission for the wireless connection of the wireless network such that the reception probability is increased for a data transmission via a wireless connection having a high path loss.

In particular, the data transmission via the wireless connection between the wireless nodes and the gateway is an unsynchronized data transmission.

Expediently, the wireless node is a sensor device, in particular a consumption meter for measuring electricity consumption or gas consumption or water consumption. Alternatively, the wireless node can be an actuator device for performing certain actions or measures, or a combination of a sensor device and an actuator device.

The wireless node, in particular the control device of the wireless node, preferably comprises a neuromorphic processor unit (NCU) or AI processor. This is a processor or chip that specializes in artificial intelligence and/or machine learning applications.

In addition, the invention also relates to a communication device. According to the invention, the communication device is a wireless node or a gateway or a head-end that is configured to perform the above noted method.

The head-end is a higher-level unit which, for instance, collects and evaluates the data transmitted in the wireless network. The head-end communicates in particular with the gateway and the wireless nodes.

Expediently, the gateway is a concentrator or data collector.

The wireless node can expediently be operated in the unlicensed ISM bands, preferably in a frequency band in the range of 865.0-868.0 MHz or 868.0-868.6 MHz or 869.4-869.65 MHz or 902-928 MHz.

The wireless node expediently works in a narrow band, i.e. the signal bandwidth of the wireless node is less than 20 KHz.

Other features which are considered as characteristic for the invention are set forth in the appended claims.

Although the invention is illustrated and described herein as embodied in a method for adapting wireless parameters, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a highly simplified representation of an exemplary bidirectional wireless network;

FIG. 2A is a block diagram of an exemplary wireless node shown in FIG. 1;

FIG. 2B is a block diagram of an exemplary gateway shown in FIG. 1;

FIG. 2C is a block diagram of an exemplary head-end shown in FIG. 1;

FIG. 3 is a highly simplified representation of a first digital twin of the wireless network shown in FIG. 1;

FIG. 4A is a flow diagram of an exemplary method procedure for adapting the at least one wireless parameter according to a first exemplary embodiment;

FIG. 4B is a block diagram of the method for adapting the wireless parameter shown in FIG. 4A;

FIG. 5 is a block diagram of the method for adapting the wireless parameter according to a second embodiment;

FIG. 6 is a block diagram of the method for adapting the wireless parameter according to a third embodiment;

FIG. 7 is a block diagram of the method for adapting the wireless parameter according to a fourth embodiment;

FIG. 8 is a diagram by way of example containing variations over time of the path loss of a wireless connection; and

FIG. 9 is a block diagram for the method procedure when test transmissions are sent.

### DETAILED DESCRIPTION OF THE INVENTION

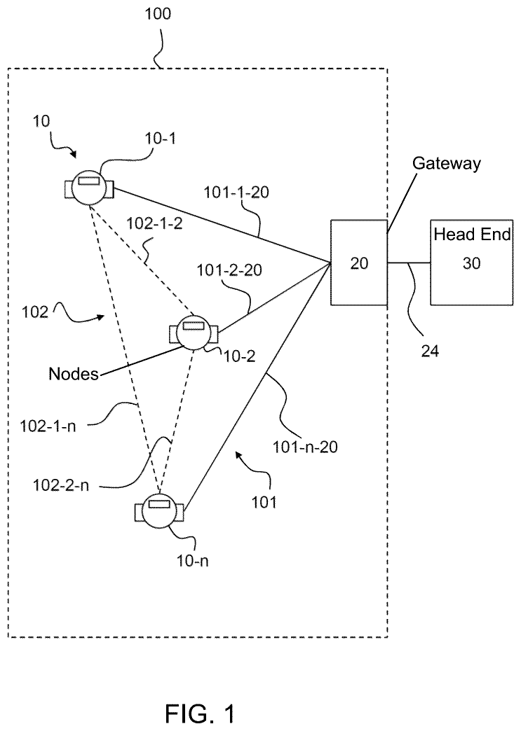

Referring now to the figures of the drawings in detail and first, particularly to FIG. 1 thereof, there is shown a highly simplified representation of an exemplary bidirectional wireless network 100. The wireless network 100 contains a plurality of wireless nodes 10 and a gateway 20. The gateway 20 can communicate with a wireless-network external head-end 30 via a bidirectional connection 24. The connection 24 can be a wireless connection or a wired connection. The wireless nodes 10 communicate with the gateway 20 via bidirectional wireless connections 101. During an uplink transmission, the wireless node 10 transfers data to the gateway 20, which can forward this data to the head-end 30. In a downlink transmission, on the other hand, data is sent from the gateway 20 to the wireless node 10. In this case, the gateway 20 can have received the downlink transmission from the head-end 30.

In the exemplary wireless network 100, three wireless nodes 10-1, 10-2, 10-n are provided, which communicate with the gateway 20. The wireless node 10-1 communicates with the gateway 20 via the wireless connection 101-1-20, the wireless node 10-2 communicates with the gateway 20 via the wireless connection 101-2-20, and the wireless node 10-n communicates with the gateway 20 via the wireless connection 101-n-20. Uplink transmissions and downlink transmissions are both possible via these wireless connections 101. More than three wireless nodes 10 can be provided in the wireless network 100.

In addition, bidirectional wireless connections 102 can be provided between the wireless nodes 10 themselves. In the present case, the wireless node 10-1 communicates with the wireless node 10-n via the wireless connection 102-1-n, the wireless node 10-1 communicates with the wireless node 10-2 via the wireless connection 102-1-2, and the wireless node 10-2 communicates with the wireless node 10-n via the wireless connection 101-2-n.

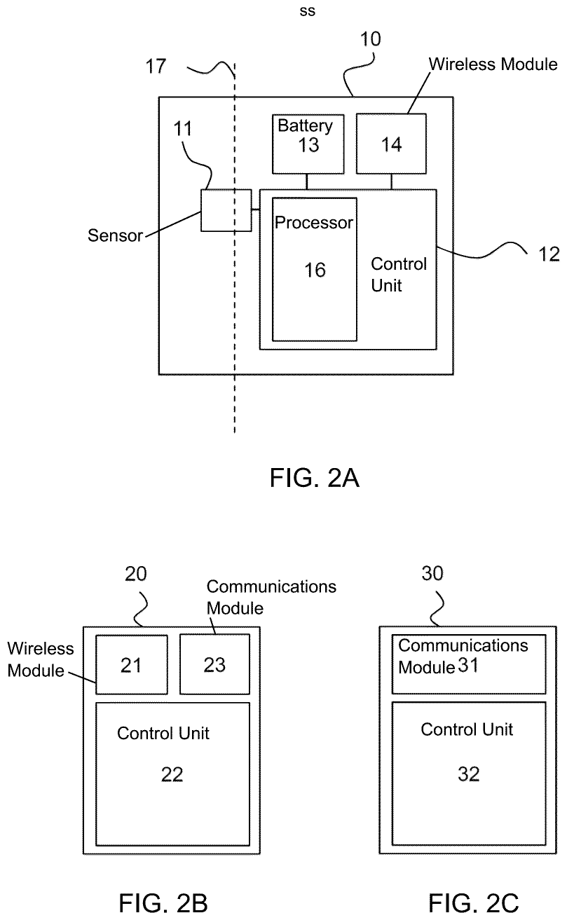

The wireless node 10 is supplied with energy via a battery 13 (see FIG. 2). The battery 13 can be a long-life battery. Normally, a service life “in the field” of at least ten years can be achieved with such a long-life battery.

The wireless node 10 also contains a control unit 12 and a wireless module 14. The wireless node 10 shown in FIG. 2 is a sensor device for capturing data of any type. The wireless node 10 contains for this purpose a sensor 11, which is located on a supply line 17, for instance for capturing electricity consumption or a flow rate of a liquid or gas. Alternatively, the wireless node 10 can also be an actuator device for performing certain actions or measures, or a combination of a sensor device and an actuator device.

The data measured by the sensor 11 is transmitted to the control unit 12. The control unit 12 can process or buffer the measured data. The wireless node 10 transmits the measured data to the gateway 20 by means of an uplink data transmission via the wireless module 14 and the associated wireless connection 101. The uplink transmission can be initiated by the control unit 12.

As shown in FIG. 2B, the gateway 20 contains a wireless module 21 for wireless communication with the wireless nodes 10, and a communication module 23 in order to communicate with the head-end 30. Alternatively, just a communication module can be provided for communication with the wireless nodes 10 and the head-end 30. In addition, a control unit 22 is provided for controlling the gateway 20. The gateway 20 receives, for example, the measured data from the wireless nodes 10, and forwards this data to the head-end 30. For example, the gateway can bundle the measured data from a plurality of wireless nodes 10, and forward this data jointly to the head-end 30.

As shown in FIG. 2C, the head-end 30 contains a communication module 31 in order to communicate with the gateway 20, for example. In addition, the head-end 30 contains a control unit 32 which, for example, processes and stores the measured data from the wireless nodes. The control unit 32 can produce in particular consumption accounts based on the measured data. The consumption accounts can then be transmitted to a supplier, for example.

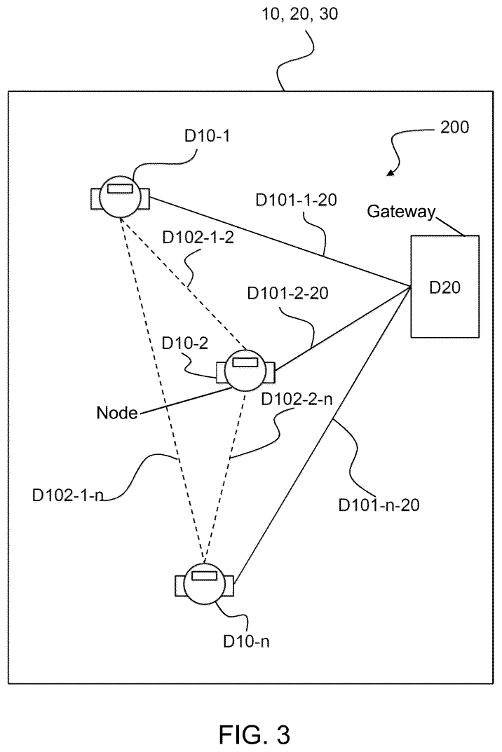

A first digital twin D100 of the wireless network 100 is provided in the wireless node 10, the gateway 20 or the head-end 30 (see FIG. 3). The first digital twin D100 is a digital reproduction of the wireless network 100. Hence all the wireless connections 101 between the wireless nodes 10 and the gateway 20 are provided as digital wireless connections D101. In addition, the wireless connections 102 between the wireless nodes 10 themselves can be provided as a digital wireless connection D102. The first digital twin D100 can be located in the control units 12, 22, 32 of the associated communication device, i.e. in the wireless node 10, the gateway 20 or the head-end 30, which can control or manage the digital twin.

The data transmissions between the wireless nodes 10 and the gateway 20 usually take place in an unsynchronized manner. This means that, for example, the uplink transmissions by the wireless nodes 10 are not synchronized and can hence be sent simultaneously. As a result, different uplink transmissions by different wireless nodes 10 can cause crosstalk and mutual interference, leading to a significant reduction in the transmission quality of the uplink transmissions. In particular, the radio signal from a wireless node 10-2 positioned closer to the gateway 20 interferes with the radio signals from a wireless node 10-1 located further away from the gateway 20. The interference can be caused just by the fact that the radio signal from the closer-positioned wireless node 10-2 has a higher energy at the gateway 20 than the radio signals from the wireless node 10-1 that is further away. This can result in the gateway 20 no longer receiving uplink transmissions from individual wireless nodes 10.

According to the invention, the Received Signal Strength Indicator RSSI is determined for each of the wireless connections 101 between the wireless nodes 10 and the gateway 20, and is used as the basis for adapting at least one wireless parameter for a future data transmission for the associated wireless connection 101. Wireless parameters are in particular the transmit power and/or the length and/or the number of repetitions and/or transmit intervals and/or data rates and/or frequency channels and/or the time of transmission of a data transmission, i.e. of an uplink transmission and/or of a downlink transmission. The reception probability of a wireless connection 101 and the quality of the data transmission can thereby be increased. In particular, it can be achieved thereby that the wireless parameters of the wireless nodes 10 are modified such that the reception probability of uplink transmissions from a wireless node 10-1 located away from the gateway 20 is increased.

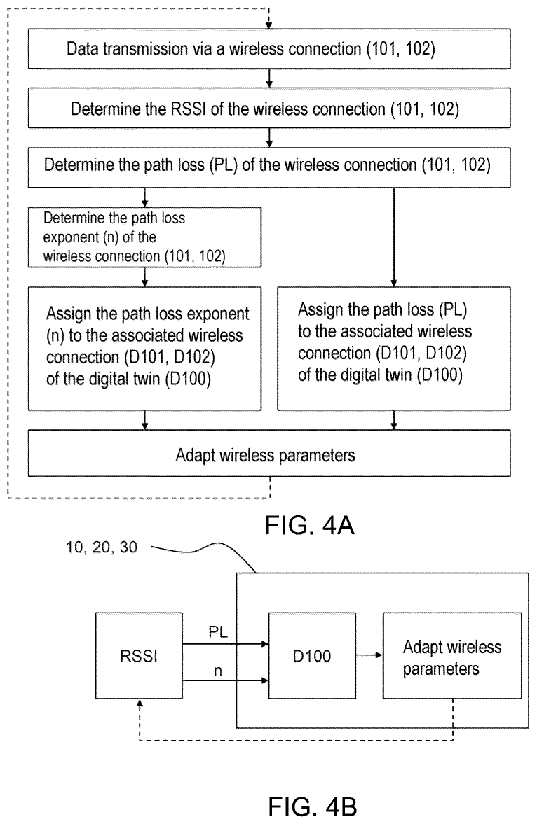

FIG. 4A shows the method according to the invention for adapting the at least one wireless parameter according to a first exemplary embodiment. First, a data transmission takes place via a wireless connection 101, 102, for instance an uplink transmission from the wireless node 10-1 to the gateway 20 via the wireless connection 101-1-20. The RSSI of the wireless connection 101-1-20 is determined from this data transmission. The RSSI is a ratio and is an indicator of the received field strength of wireless communication applications. The path loss PL for the wireless connection 101-1-20 is determined or estimated from the RSSI of the wireless connection 101-1-20. The path loss PL specifies the attenuation of the wireless connection 101-1-20 and is calculated, for example, from the formula:

$$PL = PL ( {d}_{0} ) + 10 n log ( \frac{d}{{d}_{0}} )$$

where n is the path loss exponent, d is the path length between the wireless node 10-1 and the gateway 20, d₀ is a reference distance, for instance 1 km for large wireless networks, and PL(d₀) is the path loss in decibels (dB) for the reference distance do.

From the path loss PL can additionally be determined the path loss exponent n, which can give information about the location of the wireless node 10-1. A path loss exponent n of 4 to 5 means that the wireless node 10-1 is located in a city having numerous interference sources. In addition, a path loss exponent n of about 3 means that the wireless node 10-1 is in a small town or a rural area containing few interference sources. A path loss exponent n of 2, however, means that there are no interference sources present. Thus, a high path loss exponent n means that there are numerous interferences sources or obstructions in the wireless connection 101-1-20.

The same is performed for the further wireless connections 101-2-20, 101-n-20 of the wireless network 100, so that the RSSI and the path loss PL exist for the wireless connections 101-2-20, 101-n-20, preferably for all the wireless connections 101, between the gateway 20 and the wireless nodes 10. The RSSI and/or the path loss PL can be determined, for example, by the communication device which receives the data transmission for the relevant wireless connection 101, 102, i.e. the gateway 20 in the case of an uplink transmission, or the wireless node 10 in the case of a downlink transmission. Alternatively, the RSSI and/or the path loss PL can also be determined by the communication device containing the first digital twin D100.

In the description given below by way of example, the first digital twin D100 is located in the head-end 30. It should be pointed out, however, that the first digital twin can also be located in the gateway 20 or in a wireless node 10. The path loss PL and/or the path loss exponent n of the individual wireless connections 101 are transmitted to the head-end 30. The head-end 30 assigns these to the respective wireless connections D101-1-20, D101-2-20, D101-n-20 of the first digital twin D100 so that their characteristics match those of the wireless connections 101-1-20, 101-2-20, 101-n-20 of the wireless network 100.

In addition, the RRSI can also be determined or estimated for each of the wireless connections 102 between the wireless nodes 10. Thus, the associated path loss PL and/or path loss exponent n for these wireless connections 102 can be determined or estimated from the RSSI and supplied to the first digital twin D100 in a similar way to the method described for the wireless connections 101. As a result, the first digital twin D100 additionally comprises the wireless connections D102 including the respective wireless connections D102-1-n, D102-1-2, D102-2-n. These wireless connections D102-1-n, D102-1-2, D102-2-n of the first digital twin D100 are likewise assigned the path loss PL and/or the path loss exponent n of the associated wireless connection 102-1-n, 102-1-2, 102-2-n of the wireless network 100.

On the basis of the characteristics of the wireless connections D101 and/or of the wireless connections D102 of the first digital twin D100, the head-end 30 adapts at least one wireless parameter for a future data transmission for at least one wireless connection 101 of the wireless network 100. In this process, the wireless parameters of the individual wireless connections 101 are adapted such that that the reception probability of data transmissions from wireless nodes 10-1 located away from the gateway 20 is increased, for instance by instructing interfering wireless nodes 10-2 not to perform a data transmission. For this purpose, the wireless nodes 10 and/or the gateway 20 receive the assigned associated wireless parameters from the head-end 30.

To summarize, the associated path loss PL and/or path loss exponent n of the respective wireless connections 101, 102 are determined from the RSSI of the wireless connections 101, 102 and are both assigned to the respective wireless connections D101, D102 of the first digital twin D100. The at least one wireless parameter is then adapted on the basis of the characteristics of the wireless connections D101, D102 of the first digital twin D100 (see FIG. 4B).

The adaptation of the at least one wireless parameter for the data transmissions results also in a change to the RSSI of the individual wireless connections 101, 102. Consequently, the RSSI of the wireless connections 101, 102 can be re-determined after the adaptation of the at least one wireless parameter, and the wireless parameters re-adapted on the basis thereof by means of the above-described method. This expediently creates a kind of loop, in which the wireless parameters are continuously adapted by means of the above-described method to the present RSSI of the wireless connections 101, 102. This loop is illustrated by the dashed lines in FIGS. 4A and 4B. This achieves continuous adaptation of the at least one wireless parameter to the changing characteristics of the wireless connections 101, 102.

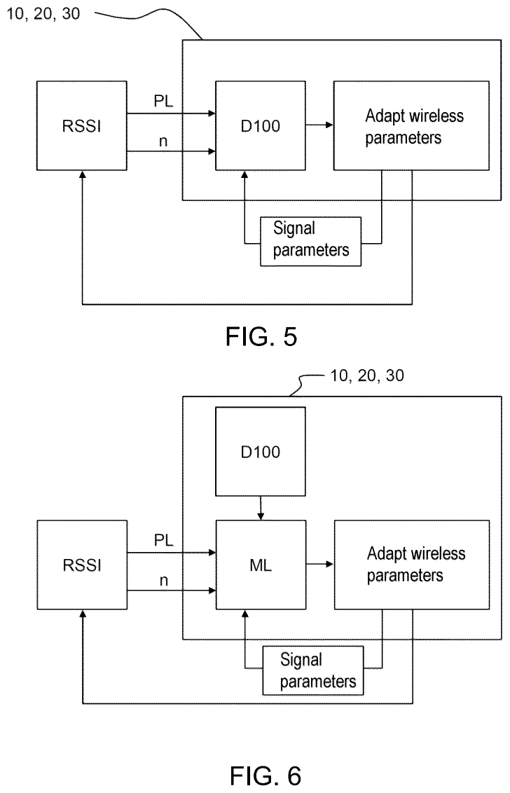

In addition to the path loss PL and the path loss exponent n, further signal parameters of the wireless connections 101, 102 of the wireless network 100 can be assigned to the wireless connections D101, D102 of the first digital twin D100, as is shown in the second exemplary embodiment given in FIG. 5. These signal parameters are, for example, the Received Signal Strength Indicator (RSSI), and/or the signal-to-noise ratio (SNR), and/or the packet error rate (PER) and/or the bit error rate (BER) of the associated wireless connection 101, 102. The first digital twin D100 thereby reflects the wireless network 100 more accurately, so that the adaptation of the at least one wireless parameter can be improved further. The adaptation of the wireless parameters influences both the signal parameters and the path loss PL and the path loss exponent n of the individual wireless connections 101, 102. It is also the case in this exemplary embodiment that the wireless parameters can be continuously updated, as described above.

In particular, the path loss PL and/or the path loss exponent n and/or the signal parameters of the wireless connections 101, 102 of the wireless network 100 are continuously assigned or saved to the respective wireless connections D101, D102 of the digital twin D100, so that the first digital twin D100 can reflect both the present characteristics of the wireless network 100 and the historical characteristics of the wireless network 100. For example, it is thus possible to form a moving average of the path loss PL and/or of the path loss exponent n and/or the signal parameters, so that outriders and/or measurement errors are given less weight in the adaptation of the wireless parameters. The at least one wireless parameter can be adapted on the basis of the present and historical characteristics.

According to a third exemplary embodiment, artificial intelligence, in particular a machine learning program ML, is provided in addition to the first digital twin D100 (see FIG. 6). The machine learning program ML is likewise located in the communication device containing the digital twin D100, and is preferably implemented by a processor or a chip.

Thus, the machine learning program can be located in the control unit 32 of the head end, in the control unit 12 of the wireless node 10 or in the control unit 22 of the gateway 20. In this case, the wireless node 10 expediently comprises a neuromorphic processor unit (NPC) 16 or an Al chip. This affords the wireless node 10 sufficient processing power for the machine learning program ML despite the typically limited processing capacity and/or energy capacity of the wireless node 10.

The machine learning program ML is trained here by the path loss PL and/or the path loss exponent n and/or the signal parameters, in particular by the associated present and historical data, of the respective wireless connections 101, 102. The machine learning program ML here comprises, for example, a statistical model, which specifies the inputs and recognizes categories and associations therefrom. Expediently, the signal parameters are filtered and/or clustered or bundled before the training of the machine learning program ML. It is hence possible to make predictions for the future characteristics of the wireless connections 101, 102 of the wireless network 100.

The machine learning program ML can be used, in particular after the training process, to predict or estimate the future characteristics, i.e. the future path loss PL and/or a future path loss exponent n and/or a future RSSI and/or future signal power and/or the future reception probability, of the wireless connections 101, 102 of the wireless network 100.

In this process, the machine learning program ML receives not only information regarding the characteristics of the wireless connections 101, 102 of the wireless network 100 from its first digital twin D100 but also the present path loss PL and/or the present path loss exponent n and/or further present signal parameters of the wireless connections 101, 102 of the wireless network 100. Expediently, the first digital twin D100 is continuously updated, as described above, and comprises also historical values for the path losses PL and/or the path loss exponents n and/or further signal parameters. Alternatively, the digital twin D100 can reflect just the characteristics of the wireless network 100 when the wireless network was initialized.

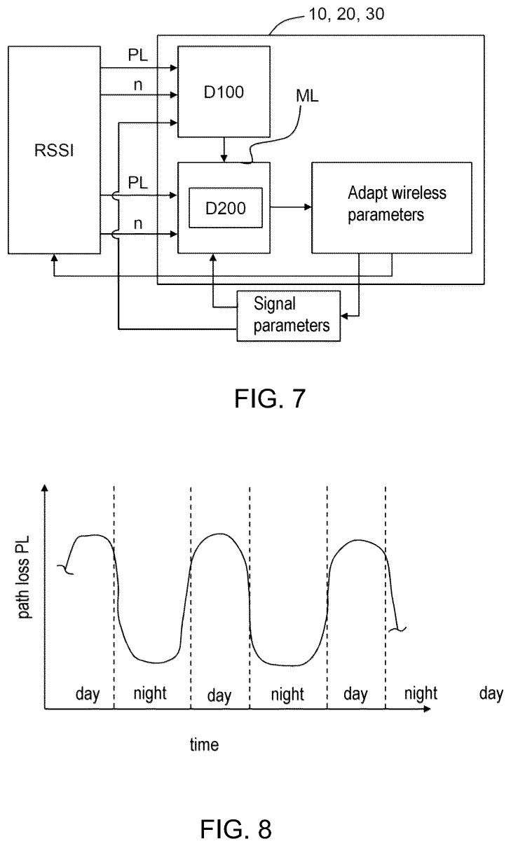

Alternatively, the machine learning program ML can comprise a second digital twin D200, which, like the first digital twin D100, comprises a digital reproduction or model of the wireless network 100 (see FIG. 7). In this case, the machine learning program ML can receive information regarding the characteristics of the wireless connections 101, 102 from the digital twin D100 and also simultaneously the present path losses and/or the present path loss exponents n and/or further present signal parameters of the wireless connections 101, 102 of the wireless network 100. Expediently, the first digital twin D100 is continuously updated, as described above, and comprises also historical values for the path losses PL and/or the path loss exponents n and/or further signal parameters. Alternatively, the digital twin D100 can reflect just the characteristics of the wireless network 100 when the wireless network was initialized. The machine learning program ML supplies the supplied data to the second digital twin D200 and uses this digital twin for further calculations.

As shown in FIGS. 6 and 7, the machine learning program ML ascertains from the supplied data the most likely characteristics of the wireless connections 101, 102 in the future, in particular for the next data transmission. The prediction or estimate by the machine learning program ML is expediently based on the method of maximum likelihood or the method of minimum mean square error.

The predicted or estimated future characteristics of the wireless connections 101, 102 are then used to adapt the at least one wireless parameter for a future data transmission for at least one wireless connection 101 of the wireless network 100. The wireless parameters are thereby adapted in advance to the most likely characteristics of the wireless connections 101, 102 of the wireless network 100, so that the reception probability and/or the reception quality of the individual wireless nodes 10 is further increased. Expediently, the future data transmission is the next data transmission.

In particular, it can be advantageous to ascertain by means of the machine learning program ML variations in the path loss PL over time. FIG. 8 shows by way of example variations in the path loss PL of a wireless node 10 over several days. It is evident here that the path loss PL is higher in daytime than at night, i.e. the wireless connection 101 is attenuated more strongly during the day. This can be ascribed to a greater volume of traffic during the day, which means that the wireless connection 101 encounters more obstructions and/or more interference sources. Such variations over time can be ascertained by means of the machine learning program ML.

The wireless parameters can be adapted on the basis thereof such that, for example, during the day, i.e. while the path loss PL is high, the wireless node 10 does not send any uplink transmissions or repeats them more frequently. For instance, the wireless node 10-1 can be instructed to perform its uplink transmissions at the time at which the wireless node 10-1 is likely to have a lower path loss PL. Expediently, in addition the radio activity of adjacent wireless nodes 10-2, 10-n can be reduced, so that the wireless connection 101-1-20 of the wireless node 10-1 has the fewest possible interference sources.

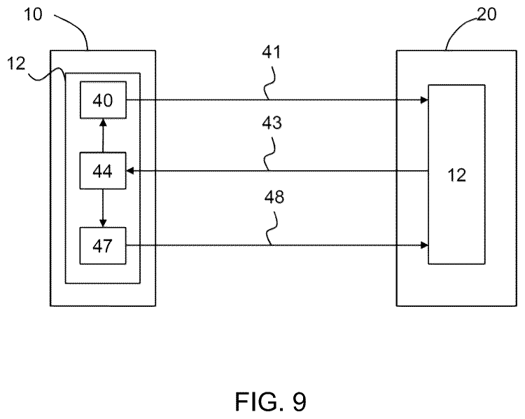

A wireless node 10 can expediently additionally perform a test transmission 41 before an uplink transmission (see FIG. 9). In this case, the wireless node 10 initiates (step 40), for instance at the time of low path loss PL, a test transmission 41, which is received by the gateway 20. The gateway 20 ascertains the quality of the test transmission 41, for instance by means of the above-described signal parameters, and transfers the quality of the test transmission 41 back to the wireless node 10 in a response 43. The wireless node 10 checks the quality of the test transmission 41 by means of the transferred response 43.

If the quality of the test transmission 41 according to the response 43 is insufficient, or no response 43 is received, for instance because the test transmission 41 was not received by the gateway 2, a test transmission 41 is re-sent, or the sending of test transmissions 41 is suspended.

If the quality of the test transmission 41 is sufficient, the data transmission 48 is initiated (step 47), and the data is sent over to the gateway 20 by means of an uplink transmission.

This is a simple way of being able to test the characteristics of the wireless connection 101. As a result, a data transmission is not initiated until there is a sufficient reception probability. The wireless node 10 can thereby save energy, because no unnecessary data transmissions are sent.

The following is a summary list of reference numerals and the corresponding structure used in the above description of the invention.

### LIST OF REFERENCES

10-1 wireless node
10-2 wireless node
10-n wireless node
11 sensor
12 control unit
13 battery
14 wireless module
16 neuromorphic processor unit (NCU)
17 supply line
20 data collector
21 wireless module
22 control unit
23 communication module
24 connection
30 head-end
31 communication module
32 control unit
40 initiate a test transmission
41 test transmission
43 response
44 check the response
47 initiate a data transmission
48 data transmission
100 wireless network
101 wireless connection
101-1-20 wireless connection
101-2-20 wireless connection
101-n-20 wireless connection
102 wireless connection
102-1-2 wireless connection
102-2-n wireless connection
102-1-n wireless connection
D100 digital twin
D101-1-20 wireless connection
D101-2-20 wireless connection
D101-n-20 wireless connection
D102-1-2 wireless connection
D102-2-n wireless connection
D102-1-n wireless connection
D200 digital twin

1. A method for adapting wireless parameters within a bidirectional wireless network containing a plurality of wireless nodes and at least one gateway, wherein wireless connections are provided between the at least one gateway and the wireless nodes, wherein the bidirectional wireless network is provided as a first digital twin in a wireless node of the wireless nodes or the at least one gateway or in a wireless-network external head-end, which comprises the steps of:
determining or estimating a received signal strength indicator (RSSI) of each of the wireless connections;
determining or estimating a path loss of each of the wireless connections from an associated said RSSI;
assigning the path loss of each of the wireless connections to respective ones of the wireless connections of the first digital twin; and
adapting, on a basis of the path loss of each of the wireless connections of the first digital twin, at least one wireless parameter for a future data transmission for at least one wireless connection of the wireless connections of the bidirectional wireless network.

2. The method according to claim 1, wherein the bidirectional wireless network additionally comprises further wireless connections between the wireless nodes, the method further comprises the steps of:
determining or estimating the RSSI of each of the further wireless connections;
determining or estimating the path loss of associated ones of the further wireless connections from associated said RSSI;
assigning the path loss of each of the further wireless connections to the further wireless connections of the first digital twin; and
using the path loss of each of the further wireless connections of the first digital twin to adapt the at least one wireless parameter for the future data transmission for at least one wireless connection of the bidirectional wireless network.

3. The method according to claim 2, which further comprises determining or estimating a path loss exponent of the wireless connections and the further wire connections.

4. The method according to claim 3, which further comprises adapting the at least one wireless parameter for the future data transmission for at least one of the wireless connections additionally according to the path loss exponent.

5. The method according to claim 3, which further comprises continuously updating the path loss and/or the path loss exponent on a basis of a latest RSSI of associated ones of the wireless connections and the further wireless connections.

6. The method according to claim 3, which further comprises continuously assigning the path loss and/or the path loss exponent of each of the wireless connections and the further wireless connections to the respective wireless connections of the first digital twin.

7. The method according to claim 2, wherein further signal parameters of individual ones of the wireless connections and the further wireless connections are determined and are used additionally to adapt the at least one wireless parameter for the future data transmission for at least one wireless connection of the bidirectional wireless network.

8. The method according to claim 3, wherein artificial intelligence is provided for predicting or estimating a future path loss and/or a future path loss exponent and/or a future RSSI for a respective one of the wireless connections and the further wireless connections.

9. The method according to claim 8, wherein the artificial intelligence additionally predicts or estimates a future signal power and/or a future reception probability.

10. The method according to claim 9, wherein the future path loss and/or the future path loss exponent and/or the future signal power and/or the future reception probability of the respective wireless connections and the further wireless connections are used to adapt the at least one wireless parameter for the future data transmission for at least one wireless connection of the bidirectional wireless network.

11. The method according to claim 8, wherein the artificial intelligence is trained by the path loss and/or the path loss exponent and/or signal parameters of an associated one of the wireless connection and/or of the further wireless connection.

12. The method according to claim 11, wherein the signal parameters are filtered and/or clustered before a training of the artificial intelligence.

13. The method according to claim 8, wherein a prediction or estimate by the artificial intelligence is based on a method of maximum likelihood or a method of minimum mean square error.

14. The method according to claim 8, wherein the artificial intelligence can determine a time at which the wireless node has a lowest path loss.

15. The method according to claim 8, wherein a second digital twin is provided in the wireless node or the at least one gateway or the wireless-network external head-end, and the artificial intelligence includes the second digital twin.

16. The method according to claim 15, wherein the second digital twin obtains information about the bidirectional wireless network from the first digital twin.

17. The method according to claim 7, which further comprises selecting the signal parameters from the group consisting of:
the received signal strength indicator (RSSI);
a signal-to-noise ratio (SNR);
a packet error rate (PER); and
a bit error rate (BER).

18. The method according to claim 1, wherein the wireless node or the at least one gateway sends a test transmission before a data transmission.

19. The method according to claim 18, wherein a data transmission takes place once the test transmission has sufficient quality.

20. The method according to claim 1, which further comprises adapting the at least one wireless parameter for the future data transmission for the at least one wireless connection of the bidirectional wireless network such that a reception probability is increased for a data transmission via the wireless connection and/or the further wireless connection having a high path loss.

21. The method according to claim 1, wherein an unsynchronized data transmission takes place via the wireless connections.

22. The method according to claim 1, wherein the wireless node is a sensor device and/or an actuator device.

23. The method according to claim 1, wherein the wireless node contains a neuromorphic processor unit.

24. A communication device being a wireless node, a gateway or a head-end, wherein the communication device is configured to implement the method according to claim 1.
